(19) United States
(12) Patent Application Publication
(10) Pub. No.: US 2020/0327091 A1
(43) Pub. Date: Oct. 15, 2020

(54) DEVICE COMMUNICATION CONTROL MODULE AND DEVICE COMMUNICATION CONTROL METHOD

(71) Applicant: Hitachi, Ltd., Tokyo (JP)

(72) Inventors: Takumi TSUJISHITA, Tokyo (JP); Masanori FUJII, Tokyo (JP); Naoya OKAMURA, Tokyo (JP)

(21) Appl. No.: 16/808,913

(22) Filed: Mar. 4, 2020

(30) Foreign Application Priority Data
Apr. 10, 2019 (JP) 2019-075021

(51) Int. Cl. G06F 13/42; G06F 13/40; G06F 9/455

(52) U.S. Cl. CPC G06F 13/4282; G06F 13/4027; G06F 2009/45579; G06F 2213/0026; G06F 9/45558

(57) ABSTRACT

A device communication control module, which performs I/O conversion for accessing a PCIe device connected to a different PCIe domain from a PCIe domain to which a CPU belongs, includes a device management table that holds a CFG address and an MMIO address corresponding to each PCIe device, and a virtual device corresponding to each PCIe device. When the CPU issues CFG access to the virtual device, the device communication control module returns an MMIO address corresponding to each PCIe device to the CPU based on information about the CFG access.

### CROSS-REFERENCE TO RELATED APPLICATION

The present application claims priority from Japanese application JP2019-075021, filed on Apr. 10, 2019, the contents of which is hereby incorporated by reference into this application.

### BACKGROUND OF THE INVENTION

### 1. Field of the Invention

The present invention relates to a device communication control module and a device communication control method, and particularly to a device communication control module and a device communication control method suitable for use in a system using a PCIe device to access a PCIe device connected from a different PCIe domain.

### 2. Description of the Related Art

Peripheral Component Interconnect Express (PCIe) is a bus standard widely distributed in all data processing devices such as a personal computer and a server as a standard for an internal high-speed bus connecting devices not depending on the CPU architecture.

PCIe is a specification in which packets are transmitted and received in a network, and devices connected to different address spaces (PCIe domains) can be accessed via a bridge.

For example, a system in which a plurality of PCIe networks is connected via a Non Transparent Bridge (NTB) is disclosed in JP 2012-83979 A. In the system described in JP 2012-83979 A, an example is shown in which different boards are NTB-connected via a bridge, and it is described that a configuration request cannot be transmitted between these boards (FIG. 9, Paragraph number 0007).

A technology described in JP 2012-83979 A corresponding to the above-described conventional technology discloses a technology for connecting two boards by the NTB and accessing each other. In general, in a system using PCIe, as a method for accessing a device by a CPU, there are Memory Mapped I/O (MMIO) access and ConFiGuration (CFG) access. An Operating System (OS) uses the CFG access to discover the device. The NTB of PCIe is a bridge for connecting a plurality of PCIe domains. Between PCIe domains connected by the NTB, MMIO access is allowed, and CFG access is not allowed. Since CFG access is not allowed, the OS cannot find a PCIe device beyond the NTB in a normal manner. For this reason, it is necessary to separately create an NTB-aware dedicated device driver for each product and use the device. For this reason, a special device driver needs to be prepared for each OS or hardware device, which leads to poor portability and a large number of software development steps.

### SUMMARY OF THE INVENTION

An object of the invention is to provide a device communication control module and a device communication control method that can operate regardless of an OS or a hardware environment in a system that accesses a device using PCIe from a plurality of PCIe domains.

A configuration of a device communication control module of the invention is preferably a device communication control module that performs I/O conversion for accessing a Peripheral Component Interconnect Express (PCIe) device connected to a different PCIe domain from a PCIe domain to which a Central Processing Unit (CPU) belongs. The device communication control module includes a device management table that holds a CFG address and an MMIO address corresponding to each PCIe device, and a virtual device corresponding to each PCIe device. When the CPU issues CFG access to the virtual device, the device communication control module returns an MMIO address corresponding to each PCIe device to the CPU based on information about the CFG access.

According to the invention, it is possible to provide a device communication control module and a device communication control method that can operate regardless of an OS or a hardware environment in a system that accesses a device using PCIe from a plurality of PCIe domains.

### BRIEF DESCRIPTION OF THE DRAWINGS

FIG. 1 is a configuration diagram illustrating an example of a data processing system using a device communication control module;

FIG. 2 is a diagram illustrating a relationship between a device communication control module and another module;

FIG. 3 is a diagram describing memory access related to device communication control;

FIG. 4 is a diagram illustrating an example of a data structure of a device management table;

FIG. 5 is a flowchart illustrating an outline from starting of a device to use of a PCIe device;

FIG. 6 is a sequence diagram of a platform initialization process;

FIG. 7 is a block diagram for describing CFG access other than a base address register;

FIG. 8 is a sequence diagram of CFG access other than the base address register;

FIG. 9 is a block diagram for describing CFG access to the base address register;

FIG. 10 is a sequence diagram of CFG access to the base address register;

FIG. 11 is a block diagram for describing MMIO access; and

FIG. 12 is a sequence diagram of MMIO access.

### DETAILED DESCRIPTION OF THE PREFERRED EMBODIMENTS

Hereinafter, embodiments of the invention will be described with reference to the drawings. The following description and drawings are examples for describing the invention, and are omitted and simplified as appropriate for clarification of the description. The invention can be implemented in various other forms. Unless otherwise specified, each component may be singular or plural.

A position, a size, a shape, a range, etc. of each component illustrated in the drawings may not represent an actual position, size, shape, range, etc., to facilitate understanding of the invention. For this reason, the invention is not limited to the position, the size, the shape, the range, etc. disclosed in the drawings.

In the following description, various types of information may be described using expressions such as “table”, “list”, “queue”, etc. However, various types of information may be expressed by a data structure other than these expressions. An “XX table”, an “XX list”, etc. may be referred to as “XX information” to indicate that the information does not depend on the data structure. In describing identification information, expressions such as “identification information”, “identifier”, “name”, “ID”, “number”, etc. are used. However, these expressions can be replaced with each other.

When there is a plurality of components having the same or similar functions, different subscripts may be assigned to the same reference numeral in the description. However, when it is unnecessary to distinguish between these components, the subscripts may be omitted in the description.

In addition, in the following description, a process performed by executing a program may be described. However, the program is executed by a processor (for example, a CPU or a GPU) to perform a predetermined process while appropriately using a storage resource (for example, a memory) and/or an interface device (for example, a communication port). Thus, a subject of the process may correspond to the processor. Similarly, the subject of the process performed by executing the program may correspond to a controller, a device, a system, a computer, or a node having the processor. The subject of the process performed by executing the program may correspond to an arithmetic unit, and may include a dedicated circuit (for example, an FPGA or an ASIC) that performs a specific process.

The program may be installed on a device such as a computer from a program source. The program source may correspond to, for example, a program distribution server or a computer-readable storage medium. When the program source corresponds to the program distribution server, the program distribution server includes a processor and a storage resource that stores a program to be distributed, and the processor of the program distribution server may distribute the program to be distributed to another computer. In addition, in the following description, two or more programs may be implemented as one program, or one program may be implemented as two or more programs.

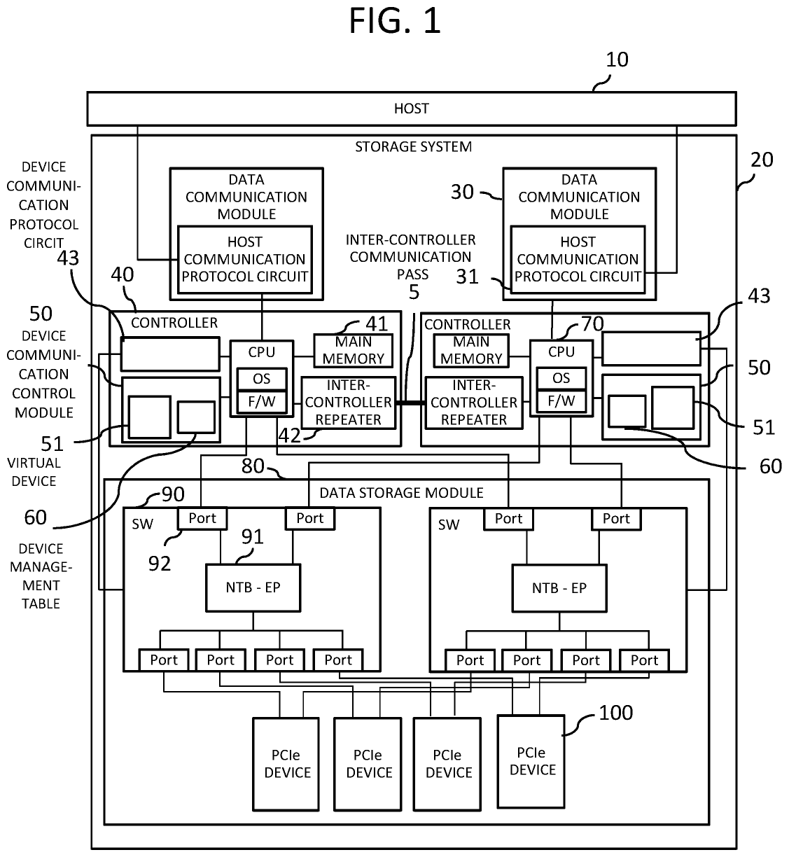

Hereinafter, the embodiments according to the invention will be described with reference to FIG. 1 to FIG. 12.

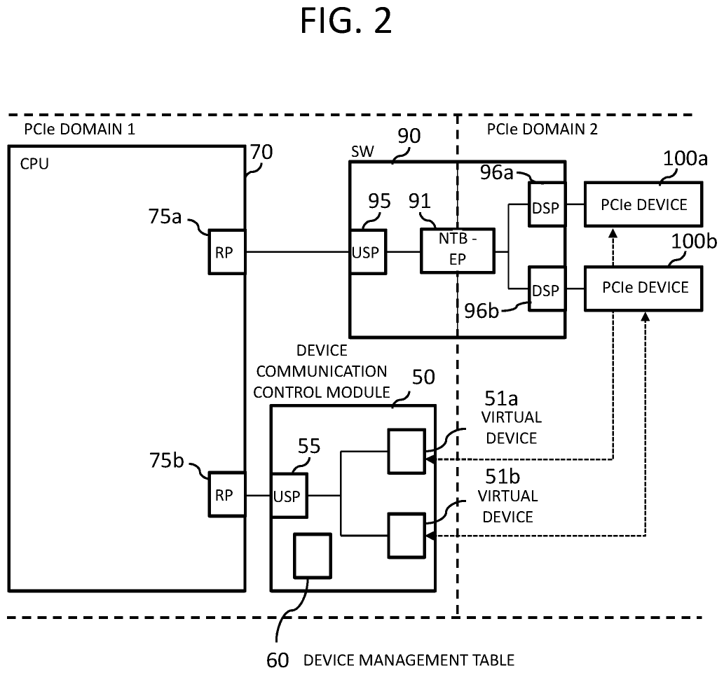

First, an outline of a configuration and operation of a device communication control module according to an embodiment of the invention will be described with reference to FIG. 1 and FIG. 2.

As an example of a data processing system using the device communication control module described in the present embodiment, a storage management system including a host 10 and a storage system 20 as illustrated in FIG. 1 will be described as an example.

The application of the device communication control module of the present embodiment is not limited to such a system, and can be used as a bus for any electronic device using PCIe.

The host 10 is an information processing device that executes a program that uses the storage system 20. The storage system 20 is a system that connects a device storing data and inputs and outputs data in response to a command from the host 10. In the present embodiment, for example, a Solid State Drive (SSD) is connected as a PCIe device 100.

The storage system 20 includes a data communication module 30, a controller 40, and a data storage module 80. The data communication module 30 is a module that incorporates a host communication protocol circuit 31, performs protocol conversion between the host 10 and the controller 40, and controls communication. The controller 40 is a part that controls the storage system 20. The data storage module 80 is a module that includes the PCIe device 100 and inputs and outputs data. In the storage system 20, controllers 40 are connected to each other by an inter-controller communication path 5.

The controller 40 includes a Central Processing Unit (CPU) 70, a main memory 41, an inter-controller repeater 42, a drive communication protocol circuit 43, and a device communication control module 50. The CPU 70 is a device that refers to data in the main memory 41, executes a program (OS, FirmWare (F/W)), and controls each unit of the storage system 20. The main memory 41 is a device that loads and holds temporary data or program. The inter-controller repeater 42 is a device that performs a logical connection between the controllers 40. The drive communication protocol circuit 43 is a module that performs protocol conversion between the controller and the data storage module 80 and controls communication. The device communication control module 50 is a module that includes a virtual device 51 and a device management table 60 and performs a function as a device in the PCIe protocol. A function and structure of the device communication control module 50 and details of the held device management table 60 will be described later.

A Switch (SW) 90 is a device that exchanges data of PCIe packets. The SW 90 includes a Port 92 for inputting/outputting a data packet and a Non Transparent Bridge Endpoint (NTB-EP) 91. The NTB-EP 91 is a bridge in the PCIe protocol and serves as a logical end point.

Next, a detailed description will be given of configurations and functions of other related modules with reference to FIG. 2, focusing on the device communication control module in the data processing system illustrated in FIG. 1.

As illustrated in FIG. 2, a communication path of the PCIe device has a tree structure that starts from a Root Port (RP) 75a of the CPU 70 and connects to the PCIe device 100 directly or via the SW 90. There is only one RP in the PCIe domain. The SW 90 has a plurality of ports, and among the ports, a port connected to the RP side is referred to as an Up Stream Port (USP) and a port on the PCIe device 100 side is referred to as a Down Stream Port (DSP). Each of the USP and the DSP is logically recognized as the SW 90 in treatment of the PCIe protocol, and is logically connected in the SW 90. As a communication path of FIG. 2, a RP 75a of the CPU 70 and a USP 95 of the SW 90 are connected, and the USP 95 is connected to a DSP 96a and a DSP 96b via the NTB-EP 91. The Non Transparent Bridge Endpoint (NTB-EP) is recognized as a PCIe device in each of a PCIe domain 1 and a PCIe domain 2.

As described in the section of the problem to be solved by the invention, in general, in a system using PCIe, there are MMIO access and CFG access as a method for the CPU to access the device.

The MMIO access is an access method in which the CPU specifies a memory address to perform reading/writing, and is used to implement a main function (such as communication) of the device. The CFG access is an access method of specifying a device by a combination of three numbers of a bus number, a device number, and a function number from the CPU and performing reading/writing, and is used for device discovery and setting. At the time of discovery, the CPU searches for a device using all possible combinations of bus, device, and function numbers (BDF), and initializes a device of the BDF that has responded.

Therefore, between PCIe domains connected by NTB-EP, the MMIO access is allowed, and the CFG access is not allowed. For this reason, the OS cannot find a PCIe device beyond the NTB-EP by a normal method. In order to solve this problem, it is necessary to create a dedicated device driver conscious of NTB for each product and use the device.

The present embodiment provides the device communication control module 50 having the virtual device corresponding to each PCIe device 100 to enable access to PCIe devices connected to different PCIe domains only by a standard function of the OS without preparing a dedicated device driver.

The virtual device 51 is a virtual device provided in the device communication control module 50 so that the CPU 70 accesses the PCIe device 100 in the external domain. One entry of the device management table 60 is set corresponding to each of the virtual devices 51 and the PCIe device 100. By issuing the CFG access to the virtual device in the device communication control module 50, the CPU 70 can obtain the same effect as that of issuing the CFG access to the PCIe device 100.

Details of the CFG access and the MMIO access using the device communication control module 50 will be described later.

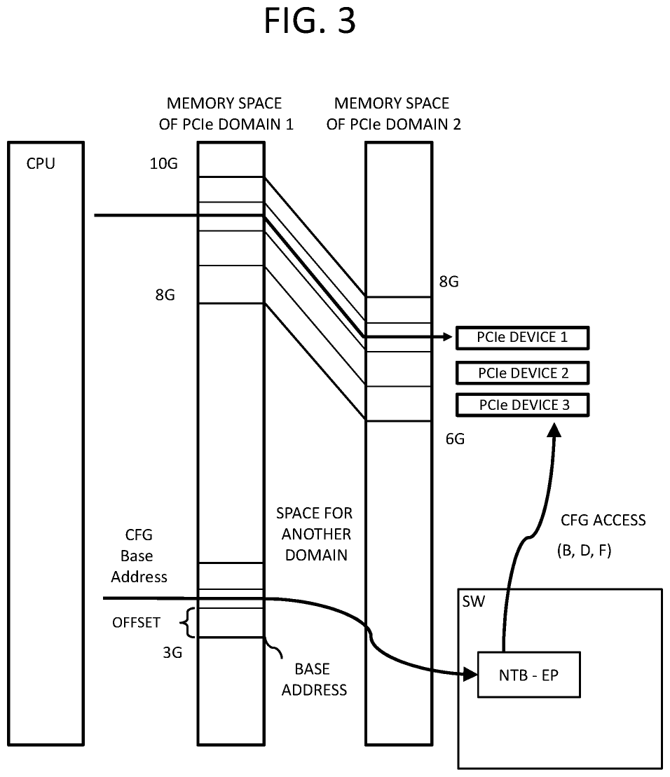

Next, memory access related to device communication control of the present embodiment will be described with reference to FIG. 3.

Here, as illustrated in FIG. 3, accessing memory spaces of the PCIe domain 1 and the PCIe domain 2 from the CPU is considered.

As described above, access between the PCIe domains across the NTB-EP can be performed only by the MMIO access. However, different memory spaces are provided on both sides of the NTB. For this reason, the MMIO access across the NTB is performed by performing address conversion of converting access to a certain specific memory area into access to a specific memory area in an opposite memory space. A scheme of performing the address conversion is determined in a hardware initialization stage by the firmware.

The PCIe device holds an MMIO address thereof (an address that determines a type, capacity, and position of the I/O space and memory space that can be used by the device) in a base address register in a configuration address space as a base address, and the CPU can obtain the MMIO address by performing the CFG access.

However, in the example of FIG. 3, since the MMIO address held by the PCIe device is an address in the memory space of the PCIe domain 2, even when the CPU accesses the address, the PCIe device cannot be accessed. In order for the CPU to access the PCIe device, the access needs to be made in consideration of the address conversion in the NTB-EP. In the example illustrated in FIG. 3, (Address accessed by CPU)−4 GB=(MMIO address of PCIe device).

In the conventional technology, since the OS needs to recognize the address conversion and then build a device driver for each platform, it is necessary for the OS to cope with each change of the platform.

Next, an address redirection function between domains provided by the SW will be described with reference to FIG. 3.

The device communication control of the present embodiment is based on the premise of the address redirection function between the domains.

A space for accessing another domain is provided in the PCIe domain 1. In the example of FIG. 3, an area from 3 GB (base address) to 256 MB is the space.

An offset based on the bus, device, and function numbers (BDF) of the PCIe device is calculated, and base address+offset is set to a CFG base address.

Then, at the time of performing the MMIO access to the NTB-EP 91 of the SW 90 (note that the NTB-EP 91 can perform the MMIO access from the PCIe domain 1), access is performed by specifying the CFG base address. The NTB-EP 91 calculates the bus, device, and function numbers (BDF) from the CFG base address and performs the CFG access to the corresponding PCIe device.

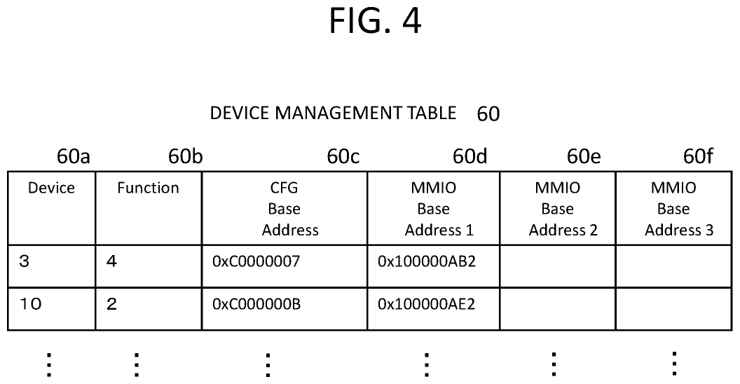

Next, a data structure of the device management table will be described with reference to FIG. 4.

The device management table 60 is a table for storing information about the PCIe device accessed by the device communication control module 50 and is a table used when a BIOS performs setting at the time of starting the device and the CPU 70 accesses the PCIe device 100.

As illustrated in FIG. 4, the device management table 60 includes respective fields of a device 60a, a function 60b, a CFG base address 60c, an MMIO base address (1) 60d, an MMIO base address (2) 60e, and an MMIO base address (3) 60f.

The device 60a and the function 60b store a device number and a function number used for the CFG access to recognize the PCIe device, respectively. In the same device communication control module 50, the bus number is fixed, and thus may not be held as table data.

The CFG base address 60c stores the CFG base address of the PCIe device viewed from the PCIe domain 1.

The MMIO base address (1) 60d, the MMIO base address (2) 60e, and the MMIO base address (3) 60f store the MMIO base address of the PCIe device viewed from the PCIe domain 1. A reason for having a plurality of MMIO base addresses is that having a plurality of base addresses is permitted by the PCIe standard.

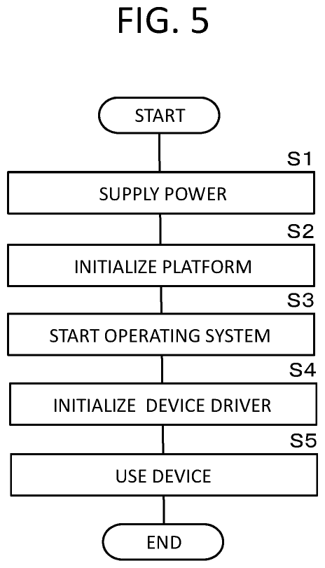

Next, processing of the device communication control module will be described with reference to FIG. 5 to FIG. 12.

First, an outline from starting of the device to the use of the PCIe device will be described with reference to FIG. 5.

First, power is supplied to the device using the PCIe device (S1).

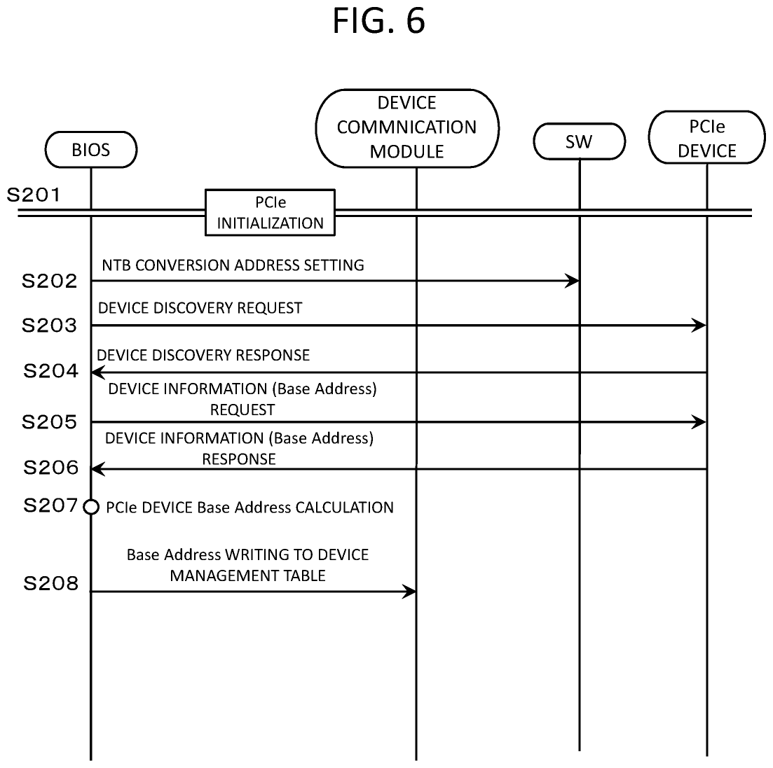

Subsequently, initialization of the platform is performed (S2). Here, the platform is a hardware and software environment of the PCIe device used for the device. The initialization of the platform will be described later in detail with reference to FIG. 6.

Subsequently, the operating system is started (S3).

Subsequently, the device driver is initialized (S4). In this step, accesses of the CFG access other than the base address register, the CFG access to the base address register, and the MMIO access are performed. Details of these processes will be described later.

Subsequently, the PCIe device is used under an operating system environment (S5).

Next, details of the platform initialization process will be described with reference to FIG. 6.

This process is a process corresponding to S2 of FIG. 5.

First, PCIe in the PCIe domain of each of the BIOS and the firmware of the SW 90 is initialized (S201).

Subsequently, the BIOS sets a conversion address of the NTB-EP 91 of the SW 90 (S202). In this way, the BIOS can access the device in the PCIe domain 2 via the NTB-EP 91.

Subsequently, the BIOS issues a discovery request to the PCIe device 100 connected beyond the SW 90 using the bus number, the device number, and the function number (S203). When the PCIe device 100 is present, the PCIe device 100 returns a response to the BIOS (S204).

When the response is returned, the BIOS requests the MMIO base address of the PCIe device 100 (S205), and acquires the MMIO base address (S206).

Then, the MMIO base address of each PCIe device 100 as viewed from the CPU 70 is calculated from the acquired MMIO base address and the set NTB conversion address, and the CFG base address is calculated from the bus number, the device number, and the function number of the device and the base address of the space for accessing another domain (S207). A method of calculation has been described with reference to FIG. 3.

Finally, the BIOS writes the MMIO base address and the CFG base address of each PCIe device in the device management table 60 of the device communication control module 50 (S208).

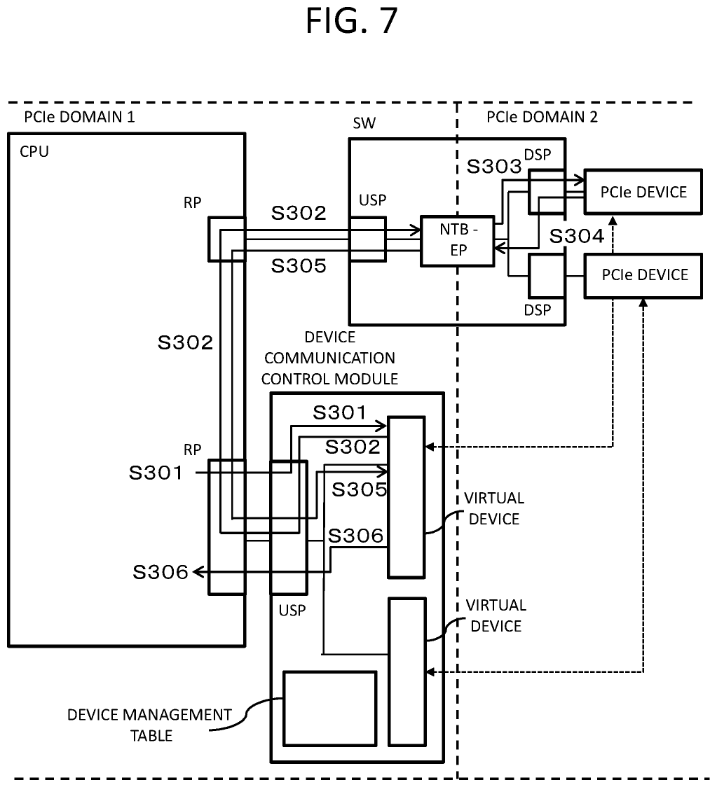

Next, a description will be given of the CFG access other than the base address register and the CFG access to the base address register with reference to FIG. 7 to FIG. 10.

This process is a process performed in S4 of FIG. 5.

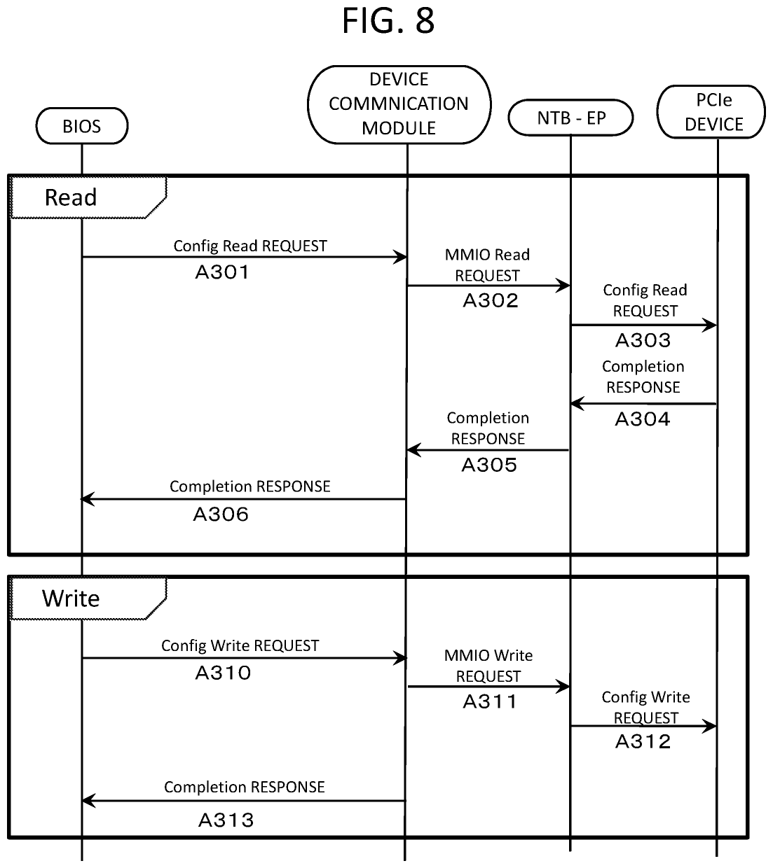

First, the CFG access other than the base address register will be described with reference to FIG. 7 and FIG. 8.

For example, the CFG access other than the base address register is CFG access used when it is difficult to find a device ID or a vendor ID in a configuration space of the PCIe device.

To perform the CFG access other than the base address register, first, the CPU 70 issues the CFG access to the virtual device 51 (S301 of FIG. 7, and A301 of Read and A310 of Write of FIG. 8).

Subsequently, the device communication control module 50 issues the MMIO access to the NTB-EP 91 using the CFG base address of the device management table 60 (S302, A302, and A311).

Subsequently, the NTB-EP 91 issues the CFG access to the PCIe device (S303, A303, and A312).

Subsequently, the PCIe device returns a CFG access response to the NTB-EP 91 (S304 and A304).

Subsequently, the NTB-EP 91 returns an MMIO access response to the virtual device 51 (S305 and A305).

Then, the virtual device 51 returns the received MMIO access response to the CPU 70 as a CFG access response (S306, A306, and A313).

Note that a response is not returned in the write access of the MMIO access due to specifications.

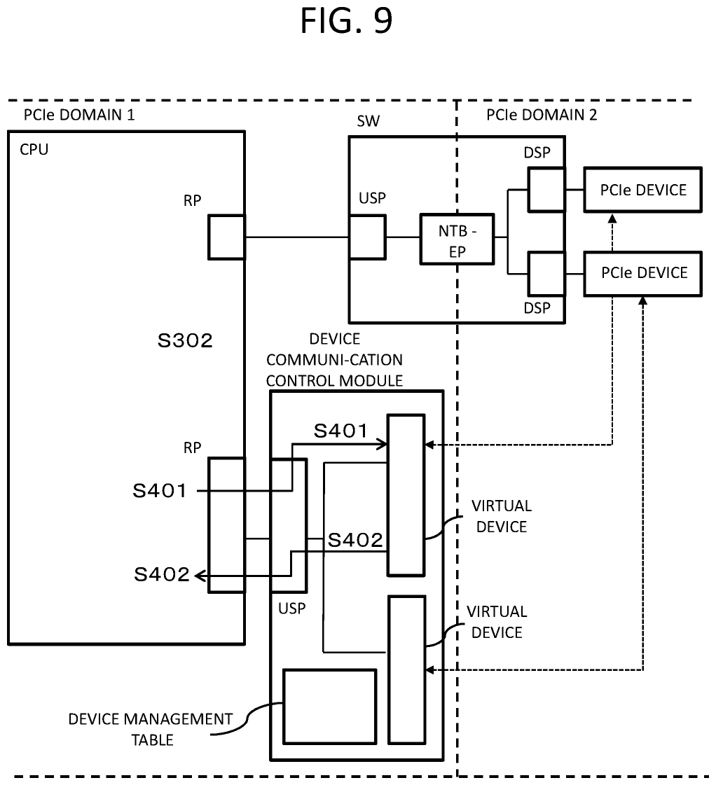

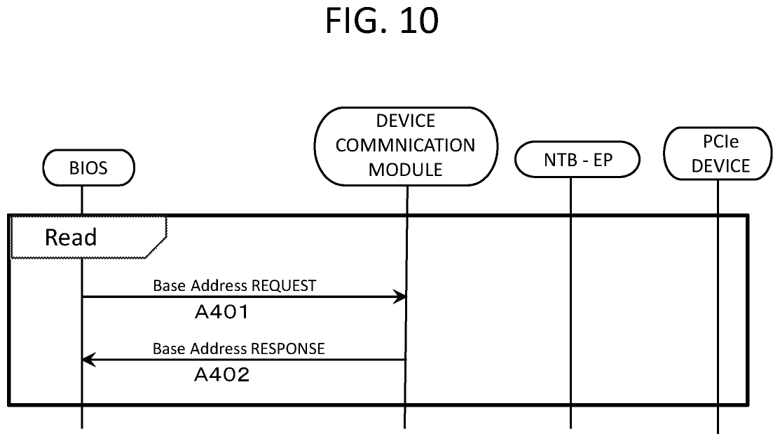

Next, the CFG access to the base address register will be described with reference to FIG. 9 and FIG. 10.

This process is a process of acquiring a base address from the base address register in the configuration space.

To perform the CFG access to the base address register, the CPU issues the CFG access for acquiring the base address to the virtual device 51 (S401 of FIG. 9 and A401 of FIG. 10).

Subsequently, the virtual device 51 returns the MMIO base address of the PCIe device to the CPU 70 based on the device management table 60 of the device communication control module 50 (S402 and A402).

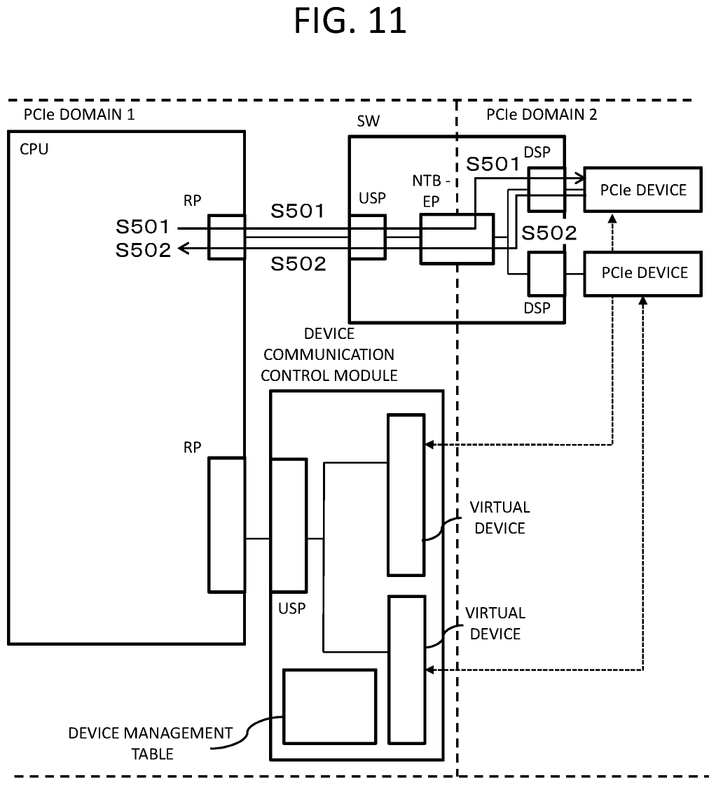

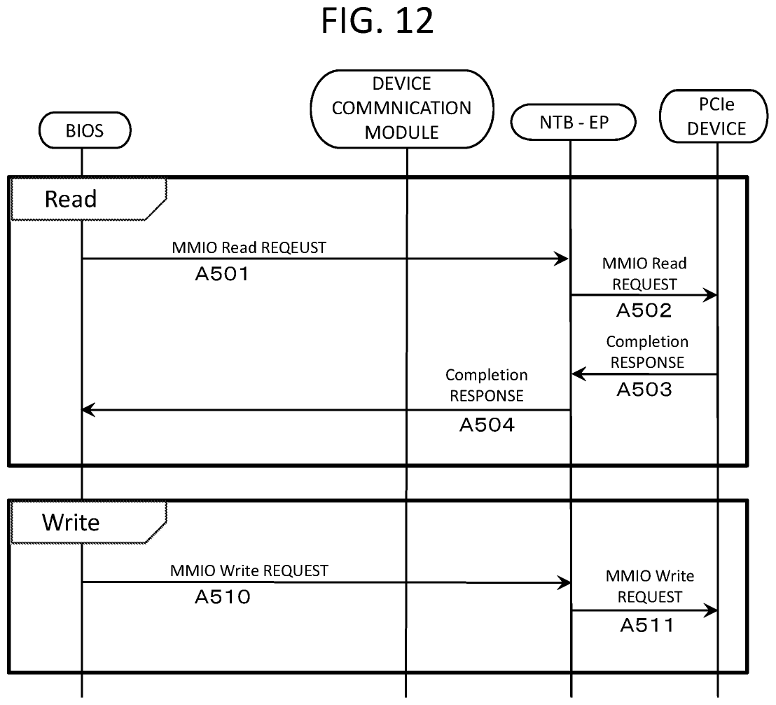

Next, the MMIO access to the PCIe device will be described with reference to FIG. 11 and FIG. 12.

This process is a process performed in S5 of FIG. 5, and is a process in which the CPU 70 actually uses the function of the PCIe device 100. At this stage, the CPU 70 finishes acquiring the base address of the PCIe device 100 by processing of the CFG access other than the base address register illustrated in FIG. 7 and the CFG access to the base address register illustrated in FIG. 9.

The CPU 70 uses the acquired MMIO base address of the PCIe device 100 to access the PCIe device 100 via the NTB-EP (S501 of FIG. 11, and A501 and A502 of Read and A510 and A511 of Write of FIG. 12).

The PCIe device 100 returns a response to the CPU 70 via the NTB-EP 91 (S502, A503, and A504).

Note that a response is not returned in the Write access of the MMIO access due to the specifications.

As described above, in the present embodiment, the communication control module including the virtual device is provided, and the CPU issues the CFG access to the virtual device corresponding to the PCIe device, so that the MMIO base address of the PCIe device is obtained. For this reason, even when a special device driver is not prepared, it is possible to use only the standard BIOS functions regardless of an OS or a hardware environment.

What is claimed is:

1. A device communication control module that performs I/O conversion for accessing a Peripheral Component Interconnect Express (PCIe) device connected to a different PCIe domain from a PCIe domain to which a Central Processing Unit (CPU) belongs, the device communication control module comprising:
a device management table that holds a CFG address and an MMIO address corresponding to each PCIe device; and
a virtual device corresponding to each PCIe device,
wherein when the CPU issues CFG access to the virtual device, an MMIO address corresponding to each PCIe device is returned to the CPU based on information about the CFG access.

2. The device communication control module according to claim 1, wherein when the CPU issues the CFG access to the virtual device, MMIO access is issued to a Non Transparent Bridge Endpoint (NTB-EP) connecting domains based on the information about the CFG access, and an MMIO access response returned from the NTB-EP is returned to the CPU as a CFG access response to the virtual device.

3. The device communication control module according to claim 1, wherein the CFG address corresponding to each PCIe device is generated from a bus number, a device number, and a function number of each PCIe device and an address of a specific area for redirection to another domain space.

4. A device communication control method of performing I/O conversion for accessing a Peripheral Component Interconnect Express (PCIe) device connected to a different PCIe domain from a PCIe domain to which a Central Processing Unit (CPU) belongs, the device communication control method comprising:
generating, by a device communication control module, a CFG address corresponding to each PCIe device from a bus number, a device number, and a function number of each PCIe device and an address of a specific area for redirection to another domain space and setting the CFG address in a device management table;
setting, by the device communication control module, an MMIO address corresponding to each PCIe device; and
returning, by the device communication control module, an MMIO address corresponding to each PCIe device to the CPU based on information about CFG access when the CPU issues the CFG access to a virtual device.

5. The device communication control method according to claim 4, further comprising
issuing, by the device communication control module, MMIO access to a Non Transparent Bridge Endpoint (NTB-EP) connecting domains based on the information about the CFG access and returning an MMIO access response returned from the NTB-EP to the CPU as a CFG access response to the virtual device when the CPU issues the CFG access to the virtual device.
